(19) United States
(12) Patent Application Publication
(10) Pub. No.: US 2010/0155219 A1
(43) Pub. Date: Jun. 24, 2010

(54) PLASMA-ENHANCED SYNTHESIS

(76) Inventors: Norbert Auner, Glashuetten (DE); Sven Holl, Glueckingen (DE); Christian Bauch, Usingen (DE); Gerd Lippold, Markkleeberg (DE); Rumen Deltschew, Leipzig (DE)

Correspondence Address: KF ROSS PC, 5683 RIVERDALE AVENUE, SUITE 203 BOX 900, BRONX, NY, 10471-0900, US

(21) Appl. No.: 12/530,662

(22) PCT Filed: Mar. 17, 2008
(86) PCT No.: PCT/EP08/02109

§ 371 Date: Feb. 11, 2010

(30) Foreign Application Priority Data
Mar. 15, 2007 (DE) 10 2007 013 219.2

(51) Int. Cl. C08G 77/12; B01J 19/08; C08G 79/00

(52) U.S. Cl. 204/157.44; 422/131; 422/186.04

(57) ABSTRACT

The invention is based on the aim of developing a device and a method for the plasma-enhanced synthesis of halogenated polysilanes and polygermanes, wherein at least one reaction partner is present in a gaseous form and is excited by reactive particles from a plasma zone, and is subsequently reacted by means of at least one further reaction partner which is present in the reaction chamber in vaporous or gaseous form. Reactions of halogen silanes or germanes of the group SiCl₄, SiF₄, GeCl₄, GeF₄ with H₂ are possible.

With the invention a device and a method for the plasma-enhanced synthesis of halogenated polysilanes and polygermanes are provided.

The invention serves for the exceptionally advantageous plasma-enhanced conversion of halogen silanes or halogen germanes to halogenated oligosilanes and polysilanes (in the following “polysilanes”) or oligogermanes and polygermanes (in the following “polygermanes”) in the form SiₙXₙ to SiₙX₍₂ₙ₊₂₎ or GeₙXₙ to GeₙX₍₂ₙ₊₂₎ by the generation and use of plasmas, the appropriate use of different plasma reaction chambers and the separation of selected plasma species for the use in the next reaction steps. Non-restricting examples for halogen silanes and halogen germanes are SiCl₄, SiF₄, GeF₄, GeCl₄.

Methods are known according to which, for instance, trichlorosilane is generated from SiCl₄ and H₂ in a plasma, as described in WO 81/03168 A1 [U.S. Pat. No. 4,309,259]

Furthermore, the generation of a plasma reaction mixture from the necessary reactants in a plasma reactor by means of electromagnetic alternating fields and/or electric fields is known, as described in DE 10 2005 024 041 A1 [US 2009/0127093].

Accordingly, a plasma-enhanced synthesis method for polysilanes and polygermanes is to be provided with which the respective reaction conditions can be better controlled with the passage of different reactions zones and rest zones.

This is obtained by a device for the plasma-enhanced synthesis of halogenated polysilanes and polygermanes with the feature of patent claim 1 as well as by a method for the plasma-enhanced synthesis of halogenated polysilanes and polygermanes with the features of patent claims 31.

The new inventive method for the plasma-enhanced synthesis of polysilanes or polygermanes in the inventive device differs from the prior art by the features that in prechambers with respect to the plasma reactor selected starting substances are ionized and dissociated by the influence of electric fields and/or electromagnetic alternating fields and selected different plasma species are supplied from one or several prechambers to the plasma reactor and are exposed there to specific reaction conditions as well as can pass different plasma reaction zones or also rest zones in order to obtain a defined final product with optimum utilization of substances and/or energy and with maximum yield. For this, for instance, it is provided to admix catalytic amounts of hydriosilanes or hydriogermanes to the reaction. By alternating modification of the cross-sectional area of the outlet channel of the reactor and/or by the use of a fall film the yield of the desired product is positively influenced.

The inventive device and the inventive method for the plasma-enhanced synthesis of halogenated polysilanes and polygermanes are shown by means of different plasma reactors in the following examples for the generation of halogenated polysilanes:

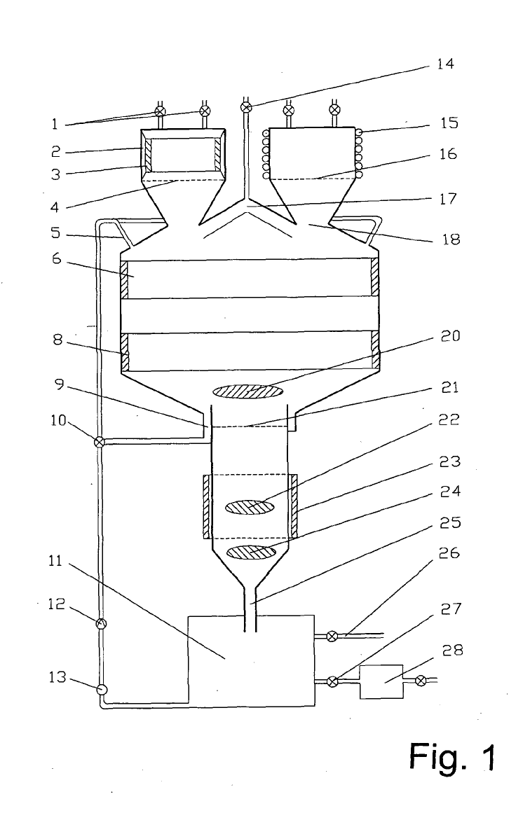

FIG. 1 shows an inventive plasma reactor in schematic representation in a first design,

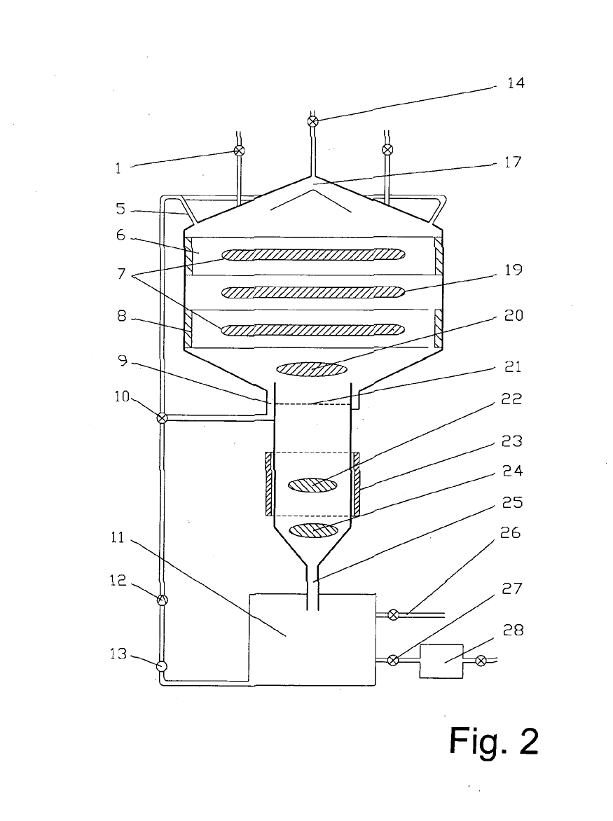

FIG. 2 shows an inventive plasma reactor in schematic representation in a second design, and

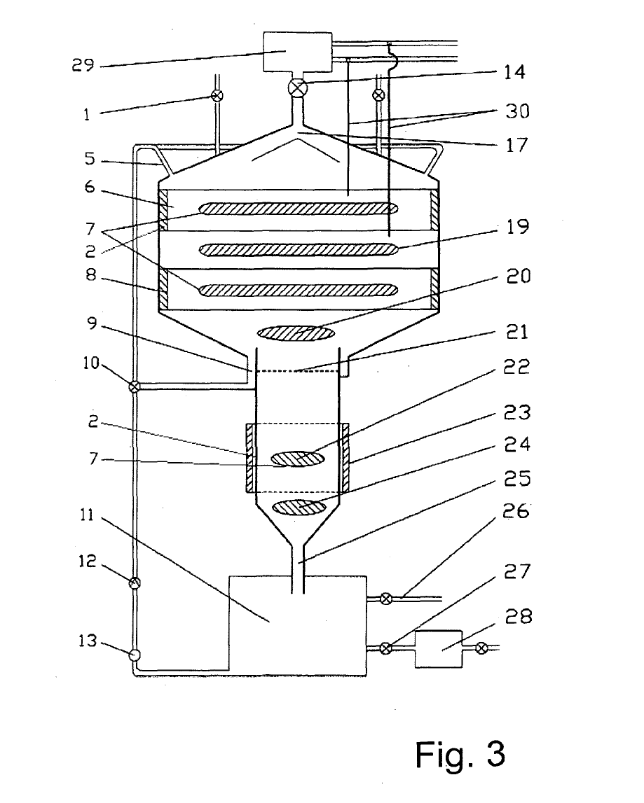

FIG. 3 shows en inventive plasma reactor in schematic representation in a third design.

The inventive device is shown in FIGS. 1 to 3. The reaction sequence is as follows:

In the design of the inventive device shown in FIG. 1: The whole equipment is thoroughly inertized and evacuated until a pressure of below 10 Pa is reached. Then, optionally the right reaction chamber 15 for the inductive plasma generation or the left reaction chamber 2 for the capacitive plasma generation is applied with reaction gas 1 “hydrogen or halogen silane/germane” through the inlet 1 until an appropriate pressure for the plasma ignition is achieved.

Now, the respective plasma source is taken in operation wherein a plasma with reaction gas 1 is ignited and the pressure in the reaction chamber is adjusted to the desired operating pressure. When doing this the electric power fed into the plasma source 2 or 15 is to be thoroughly post-adjusted so that the plasma is not extinguished. By grounding or applying a voltage to the intercepting grid for plasma species 4 or 16 the ratio between the charged plasma species and the non-charged plasma species which flow from the pre-chamber into the main chamber 31 can be selectively modified by, for instance, reflecting electrons into the prechamber or intercepting the same.

Now, the reaction gas 2 “halogen silane/germane or hydrogen” is introduced through the gas inlet 14 with careful pressure control wherein it is mixed with the reaction gas 1 through the gas diffuser 17 in the transition area between the prechamber and the main chamber 18. Additionally, an inert gas can be introduced through the respective second inlet at the prechambers for assisting the plasma ignition and/or the product generation.

In connection therewith it has to paid attention to the fact that in no way simultaneously both reaction gases are introduced into the same prechamber which is operated with the plasma since otherwise the product generation takes place at an undesired place (within the prechamber) and possibly affects the plasma stability in the further course of the reaction or even damages the plasma source 2 or 15.

However, in contrast to this it can be desirable to mix the reaction gas 2 with the reaction gas 1 for the adjustment of certain product characteristics before it comes to the reaction with the reaction gas 1 in the region 18 which was supplied through a plasma.

According to another embodiment both reaction gases, possibly diluted with inert gas, are separately excited in the prechambers by the plasma sources 2 and 15 and are supplied for the reaction into the main chamber. Reaction gas 1 and/or 2 can be introduced through the gas supply 14 in an assisting manner. The product generation takes place in the main reaction room 31 wherein the supplied reactants can be optionally exposed to an additional energy supply through a continuously 6 and/or discontinuously 8 operated microwave plasma source in the reaction zones 7 and the oligomers and polymers can be generated in the plasma zones, reaction zones 7 and rest zones 19.

The generated reaction products can be precipitated at the wall of the main reaction room 31 and can flow down at the reactor walls as fall film. Optionally, the portion of selected plasma species can be varied in the post-reaction zone 22 according to the above-described principle by the additional mounting of an intercepting grid, for instance for increasing the portion of non-charged plasma species.

In the post-reaction zone 22 and the post-rest zone 24 a quality control, for instance by spectroscopy, can be carried out for the purpose of a standardization of the reaction products which are collected in the collecting container 11 and are discharged.

A product which is deposited in the main reaction room 31 can be collected in the collecting channel 9 and can be admixed to the backwashing fraction through the mixing valve 10 in order to adjust an appropriate consistency of the backwashing solution. The product which is not collected in the collecting channel 9 flows into the collecting container 11 through the discharge pipe 25. Here, the gaseous reaction products are separated from the liquid and solid products through the drain 26. The liquid products are either drawn-off into the collecting container 28 by means of the shut-off device 27 or pressed as part-stream through the filter device 13 by means of the return pump 12 into the backwash line.

The inventive device shown in FIG. 2 is a simplified embodiment of the reactor of FIG. 1 wherein no excitation of the reaction gases in separate prechambers is provided but the application of energy rather takes place exclusively in the main reaction chamber 31 through at least one plasma source 6 and/or 8 with microwave excitation.

Reaction gas 1 is introduced through the inlet 1 and is mixed with reaction gas 2 which is supplied through the supply 14 by means of the gas diffuser 17. Optionally, inert gas can be added to the reaction mixtures through the third gas inlet for a stabilization of the plasma. When passing the plasma reaction zones 7 in the main chamber 31 the reaction gases are ionized and dissociated with the possibility that the desired reaction products are generated in the alternating reaction zones and rest zones. Moreover, the procedure takes place in an analogous manner with the procedure described in connection with FIG. 1.

The inventive device shown in FIG. 3 is an enlarged embodiment of the reactor of FIG. 2 wherein at least one plasma source 6 and/or 8 is activated with microwave excitation or high voltage excitation and mainly additional possibilities for the introduction of the reaction gases are provided.

So, optionally reaction gas 1 can be premixed with reaction gas 2 in the mixing chamber 29 before it enters the main reaction room 31. Furthermore, it is provided according to the invention that additionally not yet ionized or dissociated reactants can be supplied to the reaction zones 7 and rest zones 19 at different places in flow direction as part-amount application separately through the supply lines 30 outside of the mixing chamber 29 in order to intentionally influence the plasma reaction. Moreover, the procedure is analogous with respect to the procedure described in connection with FIG. 1.

### EXAMPLE A

FIG. 3 shows partially the function of the device in this example wherein the return pump 12 remains deactivated. Hydrogen (H₂) and silicon tetrachloride (SiCl₄) are introduced into the mixing chamber 29. The mixture of H₂ and SiCl₄ (8:1) is introduced into the reactor wherein the process pressure is maintained constant in a range of 10-20 hPa. The gas mixture passes three subsequent plasma zones 7, 22 on a length of 10 cm. The first and third plasma zone are generated by means of a high voltage discharge wherein the electrodes 2 are in direct contact with the plasma 7, 22. Thereby, the first and third plasma zone take up a power of about 10 W. The central plasma zone is generated by means of a discontinuously operated microwave source 8. The reactor is provided with an inner wall of quartz. In the region of the central plasma zone the microwave radiation enters the plasma volume through a quartz pipe having an inner diameter of 25 mm on a length of 42 mm. This plasma is generated by means of pulsed microwave radiation (2.45 GHz) with pulsed energies of 500-4,000 W and a pulse duration of 1 ms followed by 9 ms pause. This operation modus of the plasma source 8 corresponds to an equivalent mean power of 50-400 W. The product generation starts simultaneously with the ignition of the plasma sources 2, 8 and the product deposits not only in the plasma zone and reaction zone 7, 22 but also in the reaction relaxation zone 24 on a length of about 10 cm below the reaction zone 22. After 6 hours the brown up to colorless-oily product is heated to 800° C. in a tube furnace under vacuum. A grey-black residue (2.5 g) is formed which was confirmed as crystalline silicon by X-ray powder diffraction method.

### EXAMPLE B

FIG. 1 shows partially the function of the device in this example wherein the return pump 12 and the plasma sources 2, 6, 8, 23 remain deactivated. Hydrogen (H₂) and silicon tetrachloride (SiCl₄) are separately introduced into the reaction zone at different points through separate feed means. A H₂ flow of 600 sccm is passed through a commercial plasma source and is split there in the plasma of an electric discharge within the kHz range into atomic hydrogen. The gas stream containing atomic hydrogen is leaves the plasma source through an outlet opening and subsequently flows through the reactor the inner wall of which (diameter 100 mm) is lined with quartz glass. Downstream 5-10 cm below the outlet opening of the atomic hydrogen vaporous SiCl₄ is admixed to the gas stream in the quartz pipe through an annular arrangement of separate feeding means and is mixed with the starting substances in the reaction volume downstream at the outlet of the plasma source. The process pressure is maintained constant in a range of 1-5 hPa. The product generation starts simultaneously with the ignition of the plasma source 15 and the product is deposited in the reaction zone in the transition range from the prechamber to the main chamber 18 and in smaller manner in the post-reaction zone 20 on a total length of about 30 cm below the reaction zone. After a reaction time of 6 h the product is isolated from the reactor under inert gas atmosphere and is dropped as mixture with SiCl₄ into a quartz glass pipe preheated to 800° C. 5.2 g silicon are obtained as grey-black residue.

### EXAMPLE C

FIG. 3 shows partially the function of the device in this example wherein the return pump 12 remains deactivated. Hydrogen (H₂) and silicon tetrafluoride (SiF₄) are mixed with a volume of about 2.5 l stationarily with closed valve 14 in the mixing chamber 29 evacuated before to high vacuum. The adjusted equimolar mixture of H₂ and SiF₄ (45 mMol respectively) is introduced into the reactor wherein the process pressure of 10-20 hPa is maintained constant. The gas mixture passes three subsequent plasma zones 7, 22 on a length of 10 cm. The first and third plasma zone are generated by means of a high voltage discharge wherein the electrodes 2 are in direct contact with the plasma 7, 22. The first and third plasma zone take up a power of about 10 W. The central plasma zone is generated by means of a discontinuously operated microwave source 8. The reactor is provided with an inner wall of quartz. In the range of the central plasma zone the microwave radiation enters through a quartz pipe with an inner diameter of 13 mm on a length of 42 mm into the plasma volume. This plasma is generated by means of pulsed microwave radiation (2.45 GHz) with a pulse energy of 800 W and a pulse duration of 1 ms followed by 19 ms pause. This operation modus of the plasma source 8 corresponds to an equivalent mean power of 40 W. The product generation starts simultaneously with the ignition of the plasma sources 2, 8 and the product deposits not only in the plasma and reaction zone 7, 22 but also in the reaction relaxation zone 24 on a length of about 10 cm below the reaction zone 22. After about 7 h 0.63 g (about 20% of theory) of a white up to brown solid are obtained. When heating the material to 800° C. in vacuum the material decomposes and silicon is generated.

The inventive device for the realization of the plasma-enhanced synthesis of halogenated polysilanes and polygermanes is provided with the following reference numbers in FIGS. 1 to 3:

Reference List

```
  1 Feeding means for reaction gas 1 into prechamber 1
  2 Electrodes for capacitive coupling
  3 Dielectric lining of the electrodes
  4 Intercepting grid for plasma species from the prechamber with
the capacitively coupled plasma source
  5 Backwash line for gaseous or liquid reaction elements
  6 Continuously operated microwave source
  7 Plasma reaction zones 1 and 2 in the main chamber
  8 Discontinuously operated microwave source
  9 Angular intercepting channel for liquid reaction products for
backwashing
10 Mixing valve for backwashing
11 Intercepting container for reaction products
12 Return pump
13 Filter device
14 Gas feed means
15 Inductive coupling of reaction gas 2 in prechamber 2
16 Intercepting grid for plasma species from prechamber with the
inductively coupled plasma source
17 Gas diffuser
18 Transition prechamber to main chamber
19 Rest zone for reactants
20 Post-reaction zone
21 Intercepting grid for plasma species
22 Reaction zone
23 Microwave generator
24 Reaction relaxation zone
25 Discharge pipe for reaction products
26 Discharge means of gaseous reaction products with shut-off device
27 Shut-off device for liquid reaction products
28 Intercepting container for liquid reaction products
29 Mixing chamber
30 Feed lines for reactants into the reaction room
31 Main reaction room
```

1. A device for the plasma-enhanced synthesis of halogenated polysilanes and polygermanes, wherein at least one plasma source and means for passing of at least one of the selected reactants, halogen silanes and/or halogen germanes and/or hydrogen and/or inert gas through the plasma for the ionization and dissociation are provided and that at least one reaction zone and at least one rest zone are present

2. The device according to claim 1, wherein the at least one reaction zone or rest zone is disposed contiguous to or downstream with respect to the at least one plasma source and means for passing of at least one of the selected reactants.

3. The device according to claim 1 or 2, wherein the at least one reaction zone or rest zone is provided for the synthesis of the halogenated polysilanes or polygermanes

4. The device according to claim 1 wherein a mixing device for the at least one inert gas passed through the at least one plasma source with the starting substances in the reaction volume is provided downstream at the outlet of the plasma source.

5. The device according to claim 4, wherein the reaction volume is identical with or larger than the plasma volume.

6. The device according to claim 1 wherein a spatial or temporal distribution of the plasma zones or reaction zones are provided.

7. The device according to claim 1 wherein in the same at least one plasma source operated by means of electric alternating fields is provided.

8. The device according to claim 7, wherein the at least one plasma source is designed for the operation with at least one of the starting substances by means of a constant electric field.

9. The device according to claim 1 wherein at least one plasma source is formed with one of the starting substances for the extraction with priority of one kind of plasma species and for the introduction into the reaction volume.

10. The device according to claim 1 wherein at least one plasma source, operated with inert gas, is formed for the extraction of one kind of plasma species with precedence and for the introduction into the reaction volume.

11. The device according to claim 1 wherein the electric alternating field used for igniting and maintaining the gas discharge in the at least one plasma source is designed for a frequency up to VHF, preferably from 1 kHz to 130 MHz, for the generation of a plasma by means of capacitive coupling.

12. The device according to claim 11, wherein the electric alternating field used for igniting and maintaining the gas discharge in the at least one plasma source is designed with a frequency up to VHF for the generation of a plasma by means of inductive coupling.

13. The device according to claim 11 or 12, wherein an appropriate dielectric material is provided for coupling the electric alternating field into the plasma and reaction volume.

14. The device according to claim 1 wherein the at least one plasma source is provided for the operation with one of the starting substances and by means of microwave radiation.

15. The device according to claim 1 wherein the electrodes used for igniting or maintaining the gas discharge in the at least one plasma source are in direct contact with the plasma.

16. The device according to claim 1 wherein the electrodes of the plasma source or the plasma chamber walls or the reactor walls, precedently the walls of the reaction zones and rest zones, are lined or coated with material suitable for the reaction.

17. The device according to claim 15 or 16, wherein the electrodes or the plasma chamber walls or the reactor walls or the walls of the rest zones are tempered to temperatures suitable for the process.

18. The device according to claim 1 wherein at least one plasma source is provided which, for the ignition and maintenance of the gas discharge by means of a pulsed electric alternating field, is formed in such a manner that an alternating temporal distribution of the plasma and reaction zone is generated.

19. The device according to claim 18, wherein the plasma source is formed for the pulsed radiation of the microwave field into the plasma chamber.

20. The device according to claims 18, wherein the plasma source is formed for the continuous radiation of the microwave field into the plasma chamber.

21. The device according to claim 1 wherein a prechamber for mixing the educts prior to the introduction into the reaction zone or the plasma chamber is provided.

22. The device according to claim 1 wherein separate feeding means for the introduction of the starting substances at different points into the reaction zone or rest zone are provided.

23. The device according to claim 1 wherein separate feeding means for the introduction of the starting substances at different points along the pressure gradient into the reaction volume are provided.

24. The device according to claim 1 wherein at least one gas inlet for at least one of the starting substances is provided with a valve which is opened and closed in an alternating discontinuous operation modus.

25. The device according to claim 1 wherein at least one gas inlet for at least one of the starting substances is provided with a valve which alternately increases or reduces the s gas flow through the plasma source or reaction zone.

26. The device according to claim 1 wherein the gas outlet channel is provided with a valve which alternately enlarges or reduces the cross-sectional area.

27. The device according to claim 1 wherein partially plasma chamber walls or electrodes for the oligomerization or polymerization of halogen silanes or halogen germanes consist of silicon or germanium or are coated with silicon or germanium.

28. The device according to claim 1 wherein the plasma chamber walls or electrodes or reaction chamber walls consist partially or completely of a silicon compound or germanium compound of the group of the dioxides, monoxides, nitrides, carbides.

29. The device according to claim 28, wherein the plasma chamber walls or electrodes are partially or completely coated with a silicon compound or germanium compound of the group of the dioxides, s monoxides, nitrides, carbides, amorphous silicon or amorphous germanium or halogenated polysilanes or polygermanes.

30. The device according to claim 1 wherein at least one of the plasma sources contains at least one permanent magnet or electro magnet and is formed for supporting the gas discharge by means of appropriate magnetic fields.

31. A method for the plasma-enhanced synthesis of halogenated polysilanes and polygermanes with a device according to claim 1 wherein the elements Si and Ge halogenated with Cl or F are brought with H₂ in the device according to one of the preceding claims for a plasma-enhanced oligomerization or polymerization.

32. The method according to claim 31, wherein hydriosilanes or hydriogermanes in low concentrations, preferably up to 10%, are introduced into the plasma or reaction zone during an oligomerization or polymerization of halogen silanes or halogen germanes.

33. The method according to claim 31 wherein the pressure adjustment in the reactor is discontinuously realized by alternating modification of the cross-sectional area of the outlet channel.

34. The method according to one of claims 31 wherein the pressure adjustment in the reaction volume is continuously realized.

35. The method according to claim 31 wherein the plasma generation is realized in a pressure range of 0.01-1.013 hPa.

36. The method according to claim 31 wherein the plasma generation is realized in a pressure range above 1.013 hPa.

37. The method according to claim 31 wherein the plasma chamber walls, reactor walls or electrodes are partially or completely coated with halogenated polysilanes or polygermanes in the form of a fall film during the oligomerization or polymerization of halogen silanes or halogen germanes.

38. The method according to claim 37, wherein the fall film is generated by the introduction of liquid halogenated polysilanes or polygermanes into the reactor during the oligomerization or polymerization of halogen silanes or halogen germanes.

39. The method according to claim 37, wherein the fall film is generated by repumping of liquid halogenated polysilanes or polygermanes during the oligomerization or polymerization of halogen silanes or halogen germanes.

40. The method according to claim 39, wherein during the oligomerization or polymerization of halogen silanes or halogen germanes the liquid halogenated polysilanes or polygermanes are continuously renewed.

41. The method according to claim 39, wherein during the oligomerization or polymerization of halogen silanes or halogen germanes the liquid halogenated polysilanes or polygermanes are discontinuously renewed.

42. The method according to claim 31 wherein the plasma of at least one of the starting substances is localized by means of suitable magnetic fields.

43. The method according to claim 42, wherein the magnetic fields in at least one of the plasma sources are moved or are pulsed.

44. The method according to claim 31 wherein during the oligomerization or polymerization of halogen silanes or halogen germanes the generated halogenated polysilanes or polygermanes are removed from the reactor walls and electrodes by means of a wiper.

45. The method according to claim 44, wherein during the oligomerization or polymerization of halogen silanes or halogen germanes the generated halogenated polysilanes or polygermanes are discontinuously removed from the reactor walls and electrodes.
